(19) United States
(12) Patent Application Publication
(10) Pub. No.: US 2003/0133420 A1
(43) Pub. Date: Jul. 17, 2003

(54) Load balancing in data transfer networks

(76) Inventor: Wassim Haddad, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/338,875

(22) Filed: Jan. 9, 2003

(30) Foreign Application Priority Data
Jan. 9, 2002 (GB) 0200370.5

(51) Int. Cl. H04B 7/204

(52) U.S. Cl. 370/319; 370/338

(57) ABSTRACT

A data transfer network comprises a plurality of access nodes 14, 15, 16 connected to a server 12 which includes a network controller 13. A number of hosts 20, 21, 22 are arranged to communicate with the access nodes 14, 15, 16 by means of respective wireless links. The network controller 13 is arranged to monitor the load on each of the access nodes 14, 15, 16 and to control which of the access nodes is used for each of the wireless links so as to control the distribution of loads between the access nodes.

### FIELD OF THE INVENTION

The invention relates to data transfer networks and in particular to the balancing of loads between the access nodes for wireless communication within such networks.

### BACKGROUND OF THE INVENTION

The invention is applicable to any data transfer network which comprises a number of interconnected access nodes each of which can communicate by a wireless communication with a number of hosts. Examples of such networks are wireless (or partially wireless) local area networks (LANs), in which case the host can be a non-portable PC or workstation or a portable or laptop PC, and mobile phone and video phone networks in which case the host will be the mobile phone unit.

Generally with these types of networks the access nodes use the same protocol and provide the wireless communication on different channels within a range of frequencies allocated to the network. The host simply scans those frequencies to detect which access node can provide it with the clearest signal and then initiates communication with that access node at that frequency to create a suitable wireless link. If the hosts are mobile then, as they are moved within the area covered by the network, they have to transfer between access nodes in a co-ordinated process referred to as handoff. This is normally controlled separately for each host and simply connects each host to the access node which can provide the best link, usually the nearest access node. It is also known to have hybrid networks in which the host can form a link with nodes from each of a number of subnetworks using different protocols, for example the network can include one wide band short range sub-network using the Bluetooth, IEEE 802.11 or Hiperlan protocol and one longer range sub-network such as a GPRS network.

As the traffic through each access node changes, either because the activity of the hosts varies or because of handoff of hosts between nodes, the distribution of loads between the access nodes changes. It can become a problem that the distribution of loads becomes highly uneven, which can result in a sub-optimal use of the bandwidths available at the various access nodes, and unnecessarily affect the quality of service (q.o.s.) provided to the hosts.

A prior art system is disclosed in GB 2 359 701, which describes a cellular telephone network in which a telephone is caused to access a neighbouring cell if the loading on the telephone's preferred cell is too high. GB 2 297 457 describes a prior art system which allows a radio receiver to try and tune into a transmitter, other than the transmitter sending the strongest signal, if loading on the transmitter with the strongest signal is too high.

### SUMMARY OF THE INVENTION

Accordingly the present invention provides a network comprising a plurality of access nodes connected to a common communication control means, and at least one host wherein the at least one host and the access nodes are arranged to communicate with each other by means of a plurality of wireless links, and the communication control means is arranged to monitor the load on each of the access nodes and to control which of the access nodes is used for each of the wireless links so as to control the distribution of loads between the access nodes.

Generally the network will comprise a plurality of hosts which may only need one wireless link each, in which case the transfer could comprise the complete handoff of one or more hosts from one of the access nodes to another. Alternatively, in one or more of the hosts can use several wireless links simultaneously, the transfer could be of only one or some of the links in use by one of the hosts.

Preferably the communication control means is arranged to monitor the loads during communication and, if the loads on the access nodes become sufficiently unbalanced, to initiate transfer of one of the links from one of the access nodes to another. This enables the loads on the access nodes to be balanced on a substantially continuous basis.

Preferably the network comprises a plurality of hosts, wherein each host as a quality of service entitlement allocated to it, and the communication control means is arranged to take the quality of service entitlements into account when controlling the load distribution. This can help to ensure that, where for example, the quality of service provided to the hosts is determined by a charging system, a higher paying host does not receive a quality of service that falls below that of a lower paying host.

Preferably the communication control means is arranged to respond to a request for a new link from said at least one host by allocating one of the nodes to that link. This can help to avoid temporary overload of an access node as a host tries to create a link with an access node that is already carrying a lot of traffic.

More preferably the communication control means is arranged, before allowing the new link, to determine whether another link should be transferred away from one of the nodes and, if necessary, to transfer the other link.

The access nodes may form part of two different networks arranged to use different forms of wireless communication, and the at least one host may be able to communicate via said links with access nodes from each of the networks. The networks may use the same protocol and simply provide different bandwidths. Alternatively they may be different types of network such as a LAN using Hiperlan and a GPRS network. This can provide balancing not only between the access nodes of a single network, but also between different networks, giving greater flexibility in providing a suitable quality of service to all hosts.

Preferably the at least one host includes a host which can communicate two types of data substantially simultaneously and the control means is arranged to control the allocation of access nodes for the two types of data independently of each other. Again this gives a further degree of flexibility in the load balancing.

The present invention further provides a controller for a network which comprises a plurality of access nodes and at least one host wherein the at least one host and the access nodes are arranged to communicate with each other by means of a plurality of wireless links, the controller being arranged to monitor the load on each of the access nodes and to control which of the access nodes is used for each of the links so as to control the distribution of loads between the access nodes.

The present invention also provides a method of controlling the operation of a network which comprises a plurality of access nodes and at least one host wherein the at least one host and the access nodes are arranged to communicate with each other by means of a plurality of wireless links, the method comprising the steps of: monitoring the load on each of the access nodes and controlling which of the access nodes is used by each of the hosts so as to control the distribution of loads between the access nodes.

The present invention still further provides a computer readable memory device encoded with a data structure for controlling the operation of a network which comprises a plurality of access nodes and a plurality of hosts each of which can communicate by means of a wireless link with each of the access nodes, the data structure being arranged to monitor the load on each of the access nodes and to control which of the access nodes is used for each of the wireless links so as to control the distribution of loads between the access nodes.

The present invention yet further provides a computer readable medium carrying instructions which when run on a computer cause the computer to perform the method of the invention.

The present invention also provides a host arranged to communicate with a controller according to the invention.

### BRIEF DESCRIPTIONS OF THE INVENTION

Preferred embodiments of the present invention will now be described by way of example only with reference to the accompanying drawings in which:

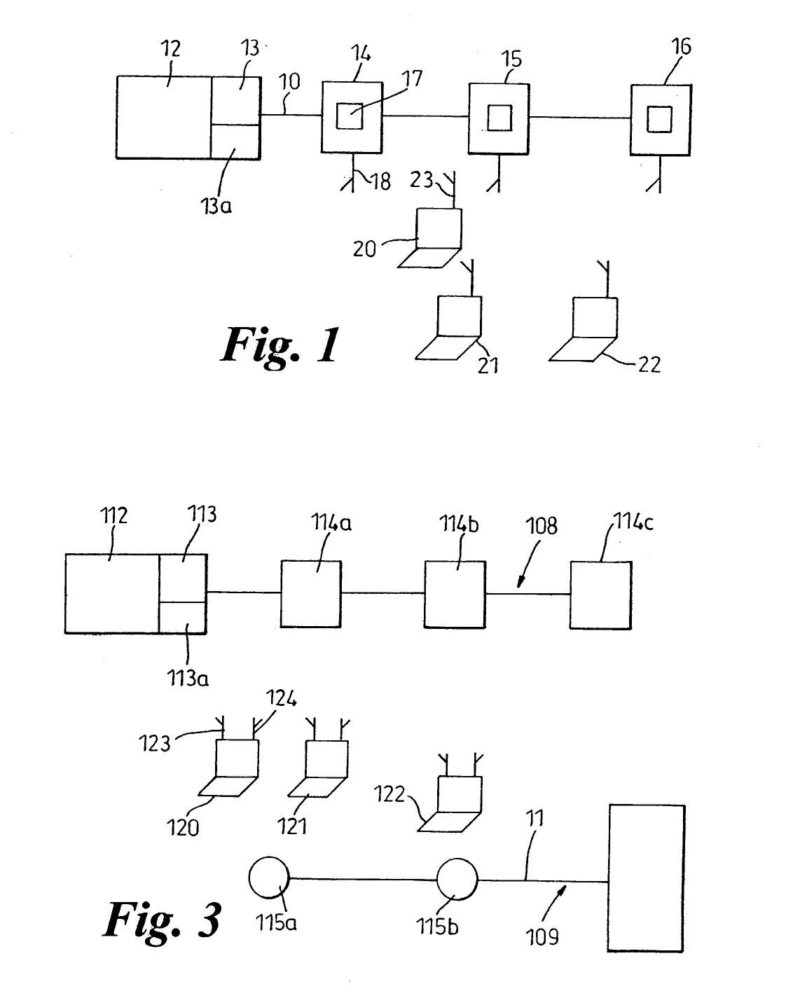

FIG. 1 is a diagrammatic representation of a wireless local area network according to a first embodiment of the invention;

FIG. 1a shows the architecture of a server forming part of the network of FIG. 1;

FIG. 1b shows the architecture of a host forming part of the network of FIG. 1

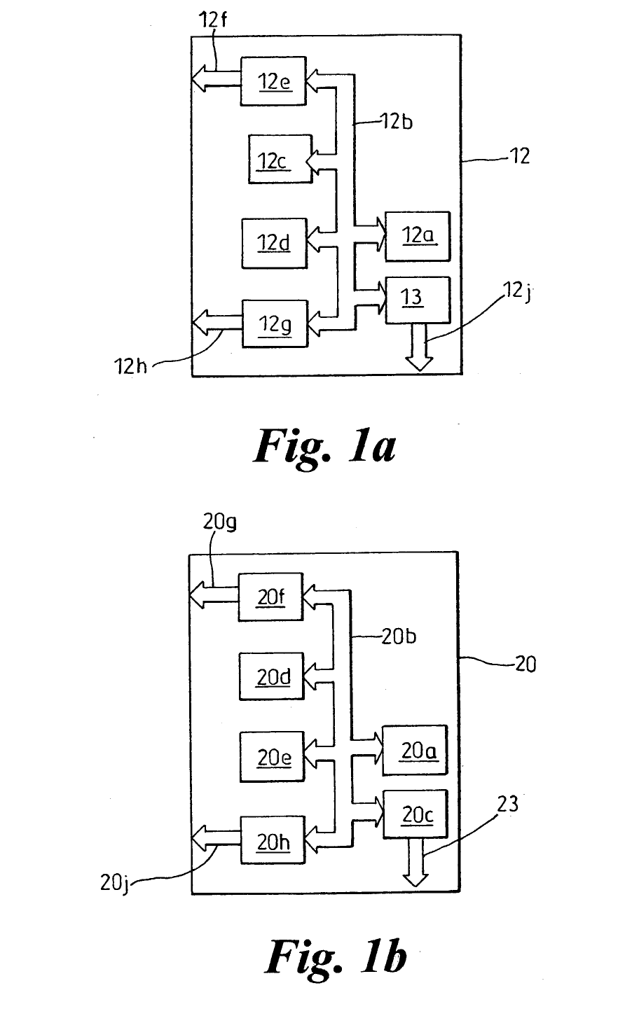

FIG. 2 is a flow diagram showing part of the operation of the network of FIG. 1;

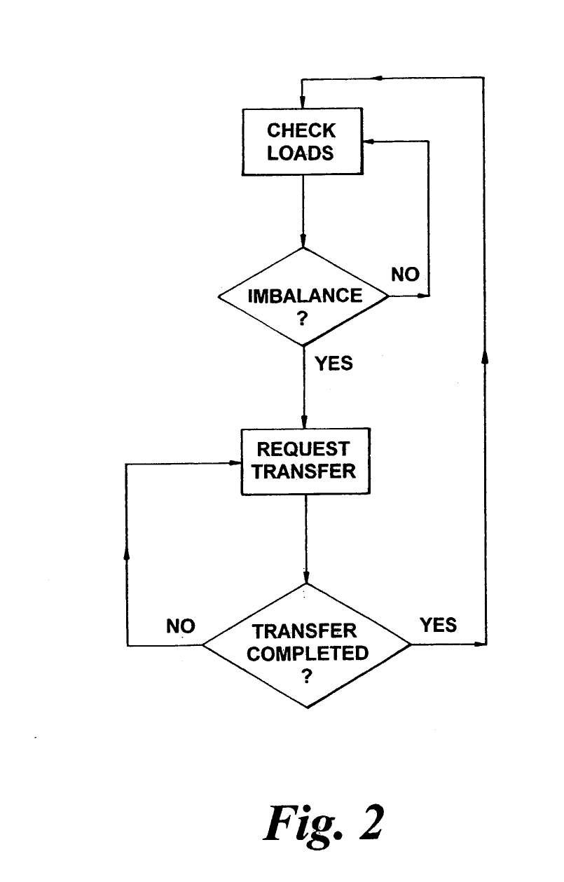

FIG. 3 is a diagrammatic representation of a wireless network according to a second embodiment of the invention;

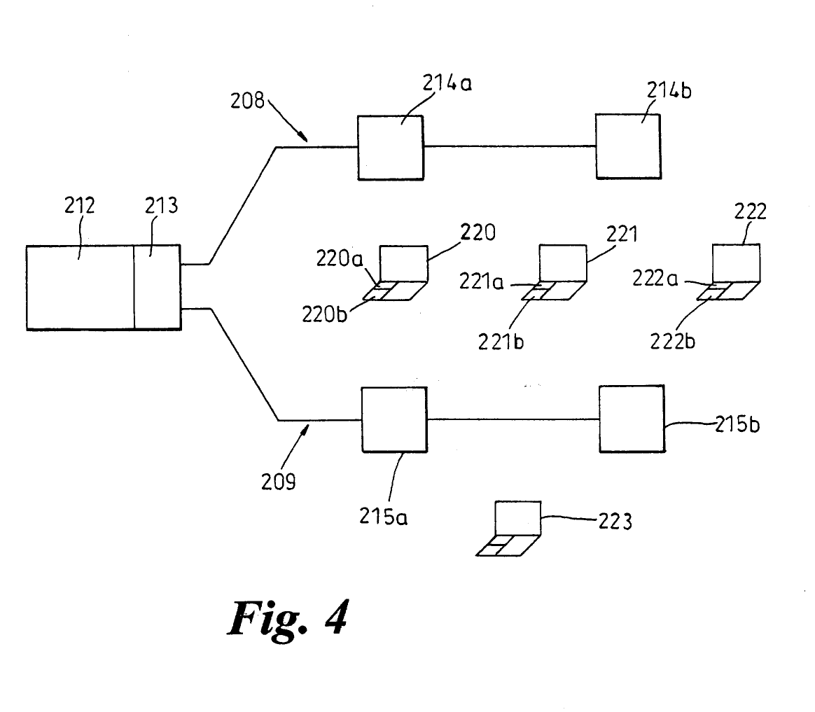

FIG. 4 is a diagrammatic representation of a multiple wireless network according to a third embodiment of the invention; and

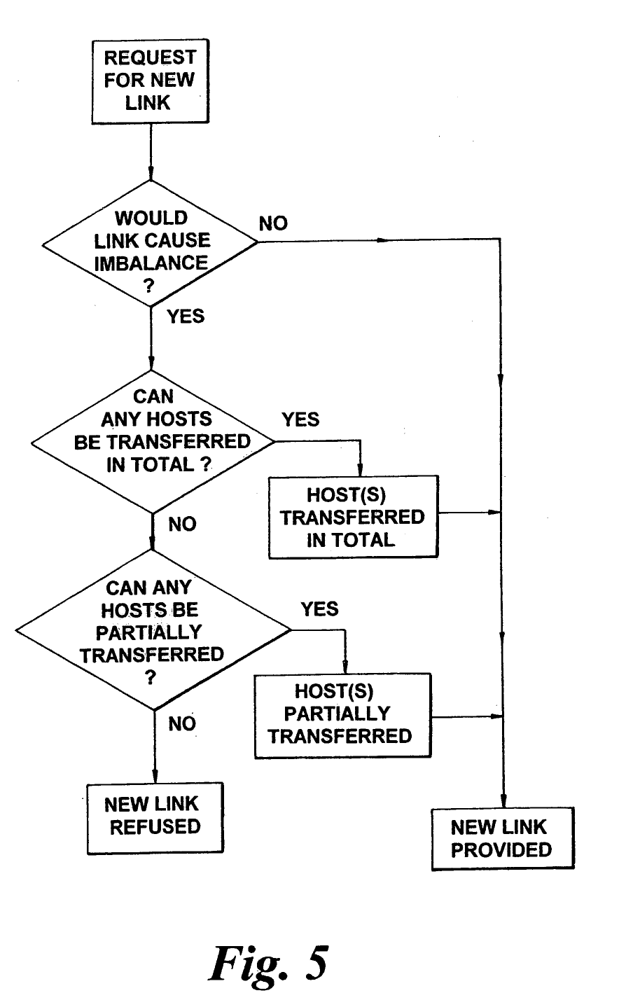

FIG. 5 is a flow diagram showing part of the operation of the network of FIG. 4.

### DETAILED DESCRIPTION OF THE INVENTION

Referring to FIG. 1, a wireless LAN comprises a backbone 10 connecting a file server 12, which includes a communication controller in the form of a network controller 13, a number of peripherals (not shown), and a number of access nodes 14, 15, 16 each including a transmitter/receiver device 17 for translating between electrical signals on the backbone and radio signals transmitted and received by an aerial 18.

The network is running under Microsoft™ Windows and the server 12 has an architecture commonly referred to as a PC architecture based around the Intel™ X86 series of chips, and compatibles. In this case the server 12 has an Intel Pentium III™ processor typically running at 900 MHz accessing 1 Gb of memory, and 50 Gb of hard disk space. Alternatively, the network may use either, or a combination, of the LINUX or/and UNIX operating systems.

FIG. 1a shows the architecture of the server in more detail. As well as the network controller 13, it also includes a processor 12a connected, via a bus 12b, to a memory 12c, and a hard drive 12d. The bus 12b also connects the processor 12a to a display driver 12e, which can drive a monitor connected to an output interface 12f. An input/output controller 12g, also connects to the bus 12b and allows a keyboard, mouse, etc. to be connected the processor 12a via ports 12h. The network controller 13 connects the processor 12a to the network backbone 10 via an output port 12j.

A number of hosts in the form of portable PCs 20, 21, 22 each of which also includes an aerial 23 are arranged to communicate with the network via a radio link with one of the access nodes 14, 15, 16. The skilled person will appreciate that each link with an access node imposes a load onto that access node. Each access node will only be able to handle a finite number of links and the upper limit may be imposed by a number of factors including the processing power of the access node and also the bandwidth available for the link.

In this embodiment the hosts are portable PC's running the Microsoft™ Windows™, LINUX or UNIX operating system. Referring to FIG. 1b, the architecture of the hosts is similar to that of the server. Each host comprises a processor 20a connected via a bus 20b to a network card 20c, a memory 20d, and a hard drive 20e. The bus 20b also connects the processor 20a to a display driver 20f, which can drive a monitor connected to an output interface 20g. An input/output controller 20h, is also connected to the bus 20b and drives a keyboard and a trackpad via connections 20k and allow as user to make inputs thereto. The wireless network card 20c connects the processor to the network via the aerial 23.

It will be appreciated that the hosts can be any suitable form of computing device, for example Apple™ iBooks™, PDA's, or telephones.

The access nodes 14, 15, 16 are arranged to communicate on different channels within the range of radio frequencies allocated to the network, and each access node transmits a regular beacon message indicating the channel on which it will communicate.

The hosts 20, 21, 22 are arranged, when they need to communicate with the network, to pick up the beacon messages of all access nodes which are within range, to determine which provides the best signal, and then to initiate communication with that access node. For example host 20 as shown in FIG. 1 is within range of two of the access nodes 14, 15 but is closest to one of them 14 than the other 15. Therefore under normal circumstances the host 20 will communicate with the closest access node 14. During its communication with that access node 14, the host 20 continuously monitors the beacon messages from any other access nodes 15 which it can receive and determines whether it could obtain a better link by changing to another one. For example if the host 20 is moved nearer to the access node 15, it would detect that that node would provide a better link and would initiate a handoff to transfer to that node. This process is referred to as a mobile controlled handoff (MCHO).

While the wireless LAN is in use the communications controller 13 controls the timing and addressing of data transmitted from the server 12 via the nodes 14, 15, 16, and monitors the data received by the server via the nodes. It also includes a software agent 13a arranged to measure the load on each of the nodes 14, 15, 16 by measuring the quantity of data addressed to it and received from it. The communications controller 13 can therefore also compare the loads on the various nodes 14, 15, 16 and determine whether they are affecting the quality of service (q.o.s.) which is being provided to any of the hosts 20, 21, 22.

If at any time the communications controller detects that one of the nodes, for example 14 as shown in FIG. 1 has a load which is affecting the speed or effectiveness of the link with any of the hosts which are communicating through it, it starts a load redistribution process as shown in FIG. 2.

Firstly, having detected the imbalance, it indicates this through node 14. This could for example be in the form of a general command addressed to all hosts that any host that is currently using node 14 but which could make an acceptable link with one of the other nodes, to transfer to that other node. If the result of this is that one of the hosts is transferred to another node, then the controller 13 will receive confirmation of this, and it then returns to monitoring the loads as before. If no transfer takes place so the load imbalance remains, the controller 13 keeps requesting a transfer until it receives confirmation that one has occurred.

It is convenient if monitoring of the load on an access node is performed at the application layer of the OSI seven layer model. Such an arrangement is convenient because it allows links associated with one particular application to be moved to another access node rather than simply moving a link of a particular technology to another access node. Indeed, some applications may have more than one link associated with them and it may allow one link from an application to be moved to another access node, whilst leaving other links connected to the same access node.

Alternatively the communications controller 13 knows each host by its medium access control (MAC) address and can address a command specifically to each of the hosts requesting that it transfer to another node if it can make a suitable link. Typically the communications controller 13 determines which node is the most appropriate for the given host to access by comparing the host's signal strength at each node. The controller 13 then selects the node with the strongest host signal strength as being the most appropriate for the host to form a link with. If there is no means for prioritizing the various hosts, then this could be done in any order, for example the last host to have connected to it could be switched over first. Alternatively the system may include some form of priority associated with each host, e.g. on the basis of payment, and the communications controller 13 could then ask the hosts of the lowest priority to switch nodes first, either individually, or by simply addressing the command to all hosts of a particular priority level.

If the communications controller 13 detects that a request for a new link to one of the nodes 14 has been made by one of the hosts 20, it checks the level of traffic that that node is carrying, and determines whether providing the newly requested link would produce an unacceptable imbalance of loads between the nodes 14, 15, 16. If it would not, the controller 13 sends a signal via the node 14 indicating that the requested link can be made, and the link is set up. If setting up the newly requested link would produce an unacceptable imbalance in the loads on the nodes, the communications controller 13 requests that any of the hosts that can use a different node, including the new host 20, should transfer to that different node. If any of the hosts does respond by transferring nodes, then the communications controller receives confirmation of this, and the new link can be set up. If no transfer results form the request then either a signal is sent to the host 20 indicating that the link is not available, or the new link can be set up with a low q.o.s., and the request for transfers repeated until the loads have been rebalanced between the nodes.

In an enhancement to this system, if each of the hosts 20, 21, 22 is capable of transmitting different types of data simultaneously though different communication channels, for example an audio signal though one channel and a video signal through another channel, then it is possible for the two types of communication to be switched between access nodes independently of each other. In this case, when a number of new links are requested by a single host 20, 21, 22 from one of the nodes 14, 15, 16, this request will be analysed by the communications controller 13 which will determine which of the requested links can be provided by that node, and which of them will need to be provided by another node. This information will then be transmitted back to the host, along with an instruction to initiate suitable data links with any node, or plurality of nodes. For example, a node can contain both Bluetooth and IEE802.11 transceivers and the instructions to the host form the controller 13 may includes instructions to form links to both of the node's transceivers. Alternatively, the instruction may be to connect to a Bluetooth transceiver one node and a HiPerlan transceiver of another node. The host can then set up the available links and request the unavailable links from another node. This clearly gives greater freedom to redistribute loads between nodes and to maximize the q.o.s. to the hosts. This can be used to ensure that, for a group of hosts, the loads are distributed so as either to give the best sound quality for all of the hosts, with the video signals taking a lower priority, or to give some hosts priority over others for both their audio and video links.

Referring to FIG. 3, in a second embodiment of the invention a multiple network comprises a number of sub-networks 108,109 each operating a different protocol. Specifically a wireless LAN, using for example the Hiperlan protocol includes a number of access nodes 114a, 114b, connected to a backbone 110, and a GPRS network includes a number of access nodes 115a,115b connected to a backbone 111. The wireless LAN includes a file server 112 connected to the backbone 110, which includes a communications controller 113 including a load distribution software agent 113a. A number of hosts 120, 121, 122 each include a first aerial 123 allowing them to communicate through a first communications channel with the wireless LAN, and a second aerial 124 allowing them to communicate through a second communications channel with the GPRS network. The hosts are arranged such that they can each communicate either with the LAN nodes 114a, 114b, 114c, or with the GPRS nodes 115a, 155b, or simultaneously with both. Initially let us assume that the hosts 120, 121 are each in video and audio communication with the same LAN node 114b, and the host 122 is in audio communication only with the GPRS node 115b. The host 122 then initiates a hybrid handoff, requesting a video and audio link with the LAN at its closest node 114b. The communications controller can determine whether the newly requested link would produce an overload of the node 114c. If it would, then prior to the handoff taking place the communications controller 113 checks whether it can redistribute the loads between the LAN nodes 114a, 114b, 114c for example by issuing a command to the second host 121 to transfer to its second closest LAN node 114a. Provided this can be achieved without unacceptable loss of quality of service to the host 121, the handoff requested by the host 122 can proceed without any reduction in quality of service caused by a temporary overload of the node 114b.

The communications controller can also co-ordinate the networks so that they can better handle the provision of different q.o.s. levels to different hosts, and changes of q.o.s. level for a particular host. This is particularly applicable where a charge is made to the hosts for a particular q.o.s. The q.o.s. to which each host 120, 121, 122 is entitled at any one time will be communicated over the network and will therefore be known to the communications controller 113, which can therefore take it into account in its control over the distribution of loads. For example, in the handoff process described above, if the host 122 were requesting only a low q.o.s. and the host 121 required a high q.o.s. then the handoff to access node 114b might not be allowed by the communications controller 113, and instead the host 122 might only be able to use another node 114c on the LAN which was within range.

Referring to FIG. 4, in a third embodiment a multiple network includes two sub-networks 208, 209 using the same protocol but different wavelengths within a particular band, and different bandwidths such that the first sub-network 208 provides a higher bandwidth that the second 209. In this case the communications controller 213 is linked to both of the subnetworks 208, 209. This allows it to balance the loads not only between the nodes 214a, 214b, 215a, 215b, of each sub-network, but also between the two sub-networks 208, 209. Again, the hosts 220, 221, 222 have a first communications channel 220a, 221a, 222a for audio links, and a second communications channel 220b, 221b, 222b for video links, and can use separate links individually or simultaneously for video and audio.

Assume, for example, that hosts 220, 221 are using node 214a for video and audio links and host 222 is using node 215b for an audio link. Then if a request for a new link, or for a change of q.o.s. is received from one of the hosts, then the communications controller performs a load redistribution process as outlined in FIG. 5. For example, if host 222 requests a video and audio link with node 214a then the communications controller 213 checks whether it can provide this without either general reduction in service or a distribution of q.o.s. not consistent with that to which the various hosts are entitled. If it can, a signal is sent to the host 22 indicating that the transfer can proceed. If it cannot, then a redistribution of loads needs to be made. The communications controller 213 checks to see whether it can therefore redistribute the loads between the two networks 208, 209 and between the nodes 124a, 214b, 214c, 215a, 215b, 215c in each network. First it checks whether any hosts can be transferred completely between nodes to achieve an acceptable load distribution. If so, then this is done. However, this might not be possible, and it might recognize that transferring the video and audio links of the hosts 220, 221 would also cause an undesirable load imbalance. It then checks whether it can partially transfer one or more of the hosts 220, 221, for example by transferring only the audio links of the hosts 220, 222 to achieve an acceptable load balance. It therefore considers node 215a and determines that transferring the audio links of hosts 220, 221 to node 215a would overload node 215a. It could therefore transfer another host 223 from node 215a to another node 215b on the second sub-network 209, then transfer the audio links of hosts 220, 221 to node 215a of the second sub-network 209, and finally give host 222 the link to node 214b that it had originally requested. This would ensure that the required load redistribution was carried out without any significant drop, either temporary or permanent, in the q.o.s. provided to the various hosts.

This type of load balance control where e.g. video and audio links can be separately redistributed could also be used in a multiple network in which the sub-networks use different protocols provided that the hosts could communicate simultaneously over the two networks. Again the various links for the various hosts could be transferred between the different networks depending on the level of traffic, their own specific requirements, and their relative assigned priorities. An example of such an embodiment would be a video link and associated audio link to a host via a WIFI link. If the load on the access node providing the WIFI link becomes too great then the audio link could be transferred to a UTMS connection. In this embodiment the video data may provide a first type of data and the audio may provide a second type of data.

It will also be appreciated that the invention could be used in a multiple network where electrical or optical links are used as well as wireless links.

1. A network comprising a plurality of access nodes, each said access node comprising a transceiver and being connected to a common communication control means for controlling access to said access node, and at least one host also comprising a transceiver wherein said at least one host and said access nodes are arranged to communicate with each other by a plurality of wireless links via respective said transceivers and each wireless link originating from one of said access nodes, said wireless links imposing a load onto said access nodes from which said link originates and said communication control means being arranged to monitor said load on each of said access nodes and to control which of said access nodes is used for each of said wireless links so as to control the distribution of said loads between said access nodes, wherein said communication control means is capable of switching at least one of said plurality of said links from one said access node to another said access node.

2. A network according to claim 1 wherein said communication control means is arranged to monitor said loads during communication and further arranged to compare said loads on each of said access nodes, if the loads on said access nodes become sufficiently unbalanced, is arranged to initiate transfer of one of said links from one of said access nodes to another of said access nodes.

3. A network according to claim 1 comprising a plurality of hosts, wherein each of said hosts has a quality of service entitlement allocated to it, and said communication control means is capable of receiving said quality of service entitlements and is arranged to take said quality of service entitlements into account when controlling said load distribution.

4. A network according to claim 1 wherein said at least one host is capable of sending a request for a new link to said communication control means which is capable of receiving said request and is arranged to respond to said request for a new link from said at least one host by allocating one of said access nodes to that new link.

5. A network according to claim 4 wherein said communication control means is capable of transferring links between access nodes and arranged, before allowing said new link, to determine whether another link should be transferred away from one of said access nodes and, if necessary, to transfer said other link to another said access node.

6. A network according to claim 1 wherein said access nodes form part of two different networks arranged to use different forms of wireless communication, and said at least one host can communicate via said links with access nodes from each of said networks.

7. A network according to claim 1 wherein at least one said host is capable of communicating two types of data substantially simultaneously and said communication control means is arranged to control allocation of said access nodes to said host for each of said two types of data independently of each other; such that a first type of data can be allocated to a first said access node and a second type of data can be allocated to a second said access node.

8. A controller for a network which comprises a plurality of access nodes and at least one host wherein said at least one host and said access nodes each comprise a transceiver and are arranged to communicate with each other by means of a plurality of wireless links via said transceivers, each wireless link imposing a load on an access node, said controller being arranged to monitor said load on each of said access nodes and to control which of said access nodes is used for each of said links so as to control the distribution of said loads between said access nodes wherein said controller is capable of switching at least one of said plurality of said links from one said access node to another said access node.

9. A controller according to claim 8 capable of transferring said links between said access nodes and arranged to monitor said loads during communication and, if said loads on said access nodes become sufficiently unbalanced, to initiate transfer of one of said links from one of said access nodes to another of said access nodes.

10. A controller according to claim 8 for a network which comprises a plurality of hosts, said controller being arranged to monitor data transferred via at least one said link to a said host to enable said controller to compare said data transferred with a quality of service entitlement associated with each of said hosts and to take said entitlement into account when controlling said load distribution.

11. A controller according to claim 8 capable of receiving requests for new links from said at least one host and arranged to respond to said request for a new link by allocating one of said access nodes to said new link.

12. A controller according to claim 11 capable of transferring said links between said access nodes and arranged, before allowing said new link, to determine whether another link should be transferred away from one of said nodes and, if necessary, to transfer said other link before allowing said new link.

13. A controller according to any one of claims 8 for a network in which at least one said host is capable of communicating two types of data substantially simultaneously, said controller being arranged to control said allocation of said access nodes to said host for each of said two types of data independently of each other, such that a first type of data can be allocated to a first access node and a second type of data can be allocated to a second said access node.

14. A method of controlling the operation of a network which comprises a plurality of access nodes and at least one host, both of said access nodes and said host comprising a communication means wherein said at least one host and said access nodes are arranged to communicate with each other by means of a plurality of wireless links via said communication means, the method comprising the steps of: monitoring the load imposed onto each of said access nodes from which a said wireless link originates and controlling which of said access nodes is used by each of said hosts so as to control the distribution of said loads between said access nodes.

15. A method according to claim 14 comprising the steps of monitoring said loads during communication and, if said loads on said access nodes become sufficiently unbalanced, initiating transfer of one of said links from one of said access nodes to another of said access nodes.

16. A method according to claim 14 for operating a network having a plurality of hosts, said method including the step of monitoring the data transferred via at least one of said links, comparing said data transferred across said link to a quality of service entitlement associated with each of said hosts, and wherein said step of controlling said distribution of said loads is performed according to the quality of service entitlement compared to the data transferred via said link.

17. A method according to claim 14 comprising the steps of receiving a request for a new link from said at least one host and, in response, checking said load distribution between said access nodes and, according to said distribution, allocating one of said nodes to said new link.

18. A method according to claim 17 comprising the step of, before allowing said new link, determining whether another link should be transferred away from said one of said access nodes and, if necessary, initiating the transfer of that other link to another said access node.

19. A method according to claim 14 wherein at least one said host can communicate two types of data substantially simultaneously, with each type of data being associated with a separate one of said links, said method comprising the steps of: determining whether load distribution can be improved by transferring one of said separate links and initiating transfer of one of those links such that a first type of data can be allocated to a first said access node and a second type of data can be allocated to a second said access node.

20. A computer readable memory device encoded with a data structure for controlling the operation of a network which comprises a plurality of access nodes and at least one host which is arranged to communicate by means of a plurality of wireless links with each of said access nodes, the data structure being arranged to cause a controller to monitor the load on each of said access nodes and to control which of said access nodes is used for each of said wireless links so as to control the distribution of loads between said access nodes wherein said data structure is capable of causing said controller to switch at least one of said plurality of said links from one said access node to another said access node.

21. A computer readable medium carrying instructions which when run on a computer cause said computer to perform said method of claim 14.

22. A host arranged to communicate with a controller according to claim 8.

23. A network comprising a plurality of access nodes each access node comprising a transceiver and being connected to a common controller, and at least one host also comprising a transceiver wherein said at least one host and said access nodes are arranged to communicate with each other by means of a plurality of wireless links via respective said transceivers, said wireless links imposing a load onto said access nodes from which said link originates and said common controller being arranged to monitor said load on each of said access nodes and to control which of said access nodes is used for each of said wireless links so as to control the distribution of said loads between said access nodes, wherein said communication control means is capable of switching at least one of said plurality of said links from one said access node to another said access node.

24. A communication control means for controlling communications associated with a hub for a wireless network for a network which comprises a plurality of said hubs and at least one processing means capable of wirelessly communicating with said hubs wherein said at least one processing means and said hubs each comprise a communication means for sending and receiving signals and are arranged to communicate with each other by means of a plurality of wireless links via said communication means, each wireless link imposing a load on one of said hubs, said communication control means being arranged to monitor said load on each of said hubs and to control which of said hubs is used for each of said wireless links so as to control the distribution of said loads between said hubs wherein said communication control means is capable of switching at least one of said plurality of said links from one said hub to another said hub.

25. A communication control means according to claim 24 which comprises one of the following group: a server; a wireless hub; a router; a hub.

26. A controller for a network which comprises a plurality of access nodes and at least one host wherein said at least one host and said access nodes each comprise a transceiver and are arranged to communicate with each other by means of a plurality of wireless links via said transceivers, each wireless link imposing a load on one of said access nodes, said controller being arranged to monitor said load on each of said access nodes and to control which of said access nodes is used for each of said links so as to control the distribution of said loads between said access nodes' wherein said controller is capable of switching at least one of said plurality of said links from one said access node to another said access node; wherein said controller determines whether to switch said link within an application layer of said controller.
